(19) United States
(12) Patent Application Publication
(10) Pub. No.: US 2009/0245634 A1
(43) Pub. Date: Oct. 1, 2009

(54) Detection of Face Area in Image

(75) Inventor: Kenji Matsuzaka, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/409,016

(22) Filed: Mar. 23, 2009

(30) Foreign Application Priority Data
Mar. 25, 2008 (JP) 2008-079232

(51) Int. Cl. G06K 9/00; G06K 9/46

(52) U.S. Cl. 382/167; 382/195; 348/E05.051

(57) ABSTRACT

An image processing apparatus. An application identification information acquisition unit acquires application identification information that identifies an application of detection results of a face area corresponding to the image of a face in a target image. A condition setting unit sets a condition, relating to an angle of the face to be represented in the face area, based on the application identification information. A face area detection unit detects the face area corresponding to the image of the face satisfying the set condition, based on image data representing the target image.

### CROSS-REFERENCE TO RELATED APPLICATIONS

This application claims the benefit of priority under 35 USC 119 of Japanese application no. 2008-079232, filed on Mar. 25, 2008, which is incorporated herein by reference.

### BACKGROUND

1. Technical Field

The present invention relates to detecting a face area in an image.

2. Related Art

Techniques of detecting a face area corresponding to an image of a face are disclosed, for example, in JP-A-2007-94633. In this disclosure, sections of an image represented by image data are successively extracted and it is then determined whether each extracted section is an image of a face.

The face area is preferably detected at a high speed.

### SUMMARY

The present invention provides a technique of detecting a face area in an image at a high speed, and may be embodied in one of the following aspects.

In accordance with one aspect of the invention, an image processing apparatus includes an application identification information acquisition unit that acquires application identification information that identifies an application of detection results of a face area corresponding to an image of a face in a target image, a condition setting unit that sets a condition, relating to an angle of the face to be represented in the face area, based on the application identification information, and a face area detection unit that detects the face area corresponding to the image of the face satisfying the set condition, based on image data representing the target image.

The image processing apparatus acquires the application identification information that identifies an application of the detection results of the face area corresponding to the image of the face in the target image, sets the condition, relating to the angle of the face to be represented in the face area, based on the application identification information, and detects the face area corresponding to the image of the face satisfying the set condition, based on image data representing the target image. A face area detection process is thus performed at a high speed.

The condition may relate to at least one of an angle of rotation of the face to be represented in the face area about an axis substantially perpendicular to a plane of the image and an angle of rotation of the face about an axis extending substantially in parallel with the plane of the image.

The image processing apparatus detects the face area corresponding to the image of the face satisfying the condition of at least one of an angle of rotation of the face to be represented in the face area about an axis substantially perpendicular to the plane of the image and an angle of rotation of the face about an axis extending in substantially parallel with the plane of the image. The face area detection process is thus performed at a high speed.

In the image processing apparatus, the face area detection unit may include a determination target setter that sets a determination target image area as an image area on the target image, a storage that stores a plurality of pieces of evaluation data, the plurality of pieces of evaluation data being predetermined in response to a value set as the condition and being used to calculate an evaluation score that represents a likelihood that the determination target image area is an image area corresponding to the image of the face satisfying the set condition, an evaluation score calculator that calculates the evaluation score, based on the evaluation data corresponding to the set condition and image data corresponding to the determination target image area, and an area setting unit that sets the face area based on the evaluation score and a position and a size of the determination target image area.

In the image processing apparatus, the determination target image area is set as the image area on the target image, and a plurality of pieces of evaluation data are stored. The plurality of pieces of evaluation data are predetermined in response to the value set as the condition and are used to calculate the evaluation score that represents a likelihood that the determination target image area is the image area corresponding to the image of the face satisfying the set condition. The evaluation score is calculated, based on the evaluation data corresponding to the set condition and image data corresponding to the determination target image area. The face area is set based on the evaluation score and the position and the size of the determination target image area. The face area detection process is thus performed in the target image at a high speed.

The area setting unit may determine based on the evaluation score whether the determination target image area is the image area corresponding to the image of the face satisfying the set condition, and set the face area based on the position and size of the determination target image area that has been determined as the image area corresponding to the image of the face satisfying the set condition.

In the image processing apparatus, it is determined based on the evaluation score whether the determination target image area is the image area corresponding to the image of the face satisfying the set condition. The face area is set based on the position and size of the determination target image area that has been determined as the image area corresponding to the image of the face satisfying the set condition. The face area detection process is thus performed in the target image at a high speed.

The application may include a predetermined image processing process that processes the image area set in accordance with the detected face area.

The image processing apparatus sets the condition in accordance with the predetermined image processing process that processes the image area set in accordance with the detected face area, and detects the face area corresponding to the image of the face satisfying the condition. The face area detection process is thus performed in the image at a high speed.

The predetermined image processing process may include at least one of a skin complexion correction operation, a metamorphosis operation, a red-eye correction operation, a determination operation determining an expression of the image of the face, and a detection operation detecting the image of the face having a particular tilt and a particular size.

The image processing apparatus sets the condition in response to at least one of the skin complexion correction operation, the metamorphosis operation, the red-eye correction operation, the determination operation determining the expression of the image of the face, and the detection operation detecting the image of the face having the particular tilt and the particular size, and detects the face area of the image of the face satisfying the condition. The face area detection process is thus performed in the target image at a high speed.

The image processing apparatus may further include an image generator that generates the image data by capturing an image of a subject. The application sets a timing of capturing the image of the subject.

The face area detection process is used to set the timing of image capturing. The image processing apparatus can thus perform the face area detection process at a high speed.

The invention may be embodied in a variety of modes. For example, the invention may be embodied as an image processing method, an image processing apparatus, a face area detection method, a face area detection apparatus, a computer program for performing these methods and functions of these apparatuses, a recording medium storing the computer program, or the like.

### BRIEF DESCRIPTION OF THE DRAWINGS

The invention will be described with reference to the accompanying drawings, wherein like numbers reference like elements.

FIG. 1 is a block diagram of a printer as an image processing apparatus in accordance with a first embodiment of the invention.

FIGS. 2A-2H illustrate types of face learning data and part learning data.

FIG. 3 is a flowchart of an image processing process in accordance with the first embodiment of the invention.

FIG. 4 is a diagram of a user interface for setting an image processing mode.

FIG. 5 illustrates a condition table.

FIGS. 6A-6E illustrate a setting method of an operative window size.

FIG. 7 is a flowchart of a face area detection process.

FIG. 8 illustrates the face area detection process.

FIG. 9 illustrates a calculation method of a cumulative evaluation score Tv to be used in a face determination.

FIG. 10 illustrates sample images used in a learning operation that sets the face learning data corresponding to a full-faced face.

FIGS. 11A and 11B diagrammatically illustrate a face area setting process.

FIGS. 12A-12C diagrammatically illustrate the face area setting process.

FIG. 13 is a flowchart of a part area detection process.

FIG. 14 diagrammatically illustrates the part area detection process.

FIG. 15 is a block diagram of a printer as an image processing apparatus in accordance with a second embodiment of the invention.

FIG. 16 is a flowchart of an image processing flow in accordance with the second embodiment of the invention.

FIG. 17 illustrates displayed face area detection results.

### DESCRIPTION OF EXEMPLARY EMBODIMENTS OF THE INVENTION

### First Embodiment

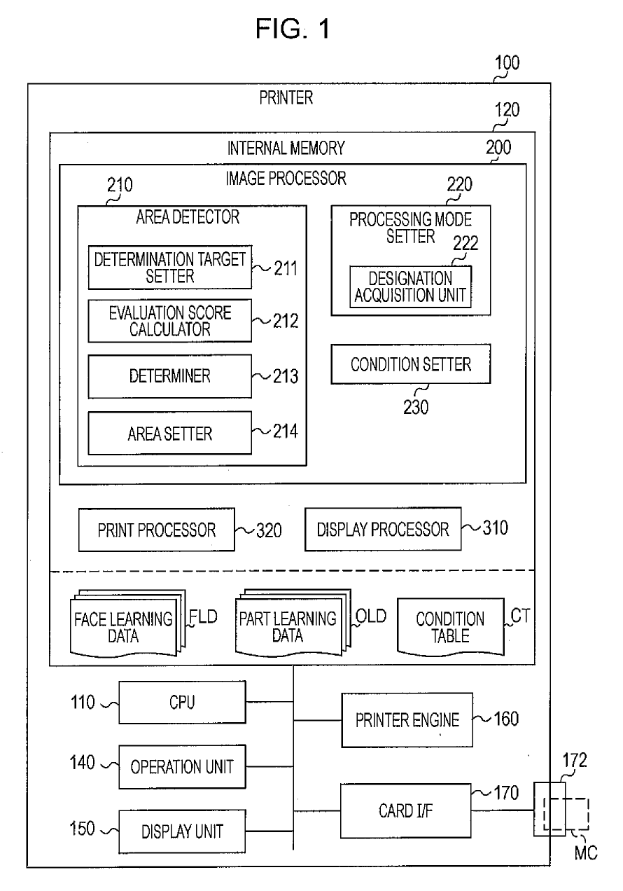

FIG. 1 illustrates a structure of a printer 100 as an image processing apparatus in accordance with a first embodiment of the invention. The printer 100 is an ink jet printer supporting a direct print method. The printer 100 prints an image in response to image data acquired from a memory card MC or the like. The printer 100 includes a central processing unit (CPU) 110 controlling elements of the printer 100, an internal memory 120 including a read-only memory (ROM) and a random-access memory (RAM), an operation unit 140 including buttons and a touchpanel, a display unit 150 including a liquid-crystal display, a printer engine 160, and a card interface 170. The printer 100 may further include an interface for performing data communication with another device (such as a digital still camera or a personal computer). The elements of the printer 100 are mutually connected to each other via a bus.

The printer engine 160 is a print mechanism for performing a print operation in response to print data. The card interface 170 exchanges data with a memory card MC inserted into a card slot 172. In the first embodiment, the memory card MC stores a image file containing image data.

The internal memory 120 is a computer-readable medium including an image processor 200, a display processor 310, and a printer processor 320. Under the control of a predetermined operating system, the image processor 200 is a computer program embodied in memory 120 that executes an image processing process to be discussed later. The display processor 310 as a display driver controls the display unit 150, thereby displaying on the display unit 150 a process menu, a message, an image, etc. The printer processor 320 as a computer program embodied in memory 120 controls the printer engine 160, thereby printing an image responsive to the print data. The CPU 110 reads from the internal memory 120 these programs and executes the read programs in order to perform the function of each element.

The image processor 200, as a program module, includes an area detector 210, a processing mode setter 220, and a condition setter 230. The area detector 210 detects a face area of an image of a subject of a predetermined type (an image of a face and an image of a part of the face) in a target image represented by target image data. The area detector 210 includes a determination target setter 211, an evaluation score calculator 212, a determiner 213, and an area setter 214. The functions of these elements will be described later in the discussion of the image processing process. The area detector 210 functions as a face area detection unit that detects a face area of an image of a face. The determiner 213 and the area setter 214 function as an area setting unit.

The processing mode setter 220 sets a mode of the image processing process to be executed. The processing mode setter 220 includes a designation acquisition unit 222 that acquires a mode of the image processing process designated by the user. The condition setter 230 sets a condition related to an angle or the like of a face displayed in a face area detected in the image processing process.

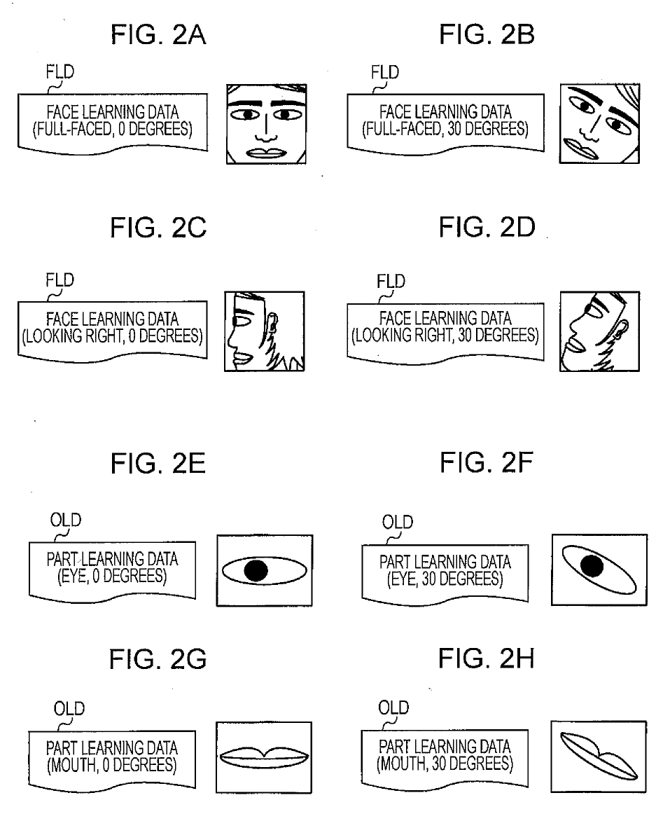

The internal memory 120 stores a plurality of pieces of preset face learning data FLD and a plurality of pieces of preset part learning data OLD. The face learning data FLD and the part learning data OLD are used when the area detector 210 detects a predetermined image area. FIGS. 2A-2H illustrate types of face learning data FLD and part learning data OLD, and examples of image areas detected using the types of face learning data FLD and part learning data OLD.

The content of the face learning data FLD is described later in the discussion of the image processing process. The face learning data FLD is set in association with a face tilt and a face orientation of a face. The face tilt means the tilt of the face (angle of rotation) within the plane of the image (in-plane tilt). More specifically, the face tilt is an angle of rotation about an axis substantially perpendicular to the plane of the image. In accordance with the first embodiment of the invention, a tilt of each of an area of a target image, a subject, and other feature is represented by an angle of clockwise rotation from a reference state (with the tilt being zero). The reference state is a state in which an upward looking direction of each of the area of the target image, the subject, and the other feature matches an upward looking direction of the target image. More specifically, the face tilt is represented by an angle of clockwise rotation of the face from the reference state. The reference state (with the face tilt=O) is a state in which the face is positioned along a substantially vertical direction of the target image (with the top of the head looking upward and the jaw looking downward).

The face orientation means an out-plane orientation of the face (a turnaround angle of the face). The turnaround angle of the face refers to an angle at which the face looks about an axis of the neck having a substantially circular cylindrical shape. More specifically, the face orientation is an angle of rotation of the face about an axis extending substantially in parallel with the plane of the image. In accordance with the first embodiment of the invention, the orientation of the face looking toward an imaging plane of an image generating apparatus such as a digital still camera is referred to as a “full-faced orientation,” the orientation of the face looking rightward if viewed from the imaging plane is referred to as a “rightward looking orientation” (with the image of the face looking leftward if viewed from an observer of the image) and the orientation of the face looking leftward if viewed from the imaging place is referred to as a “leftward looking orientation” (with the image of the face looking leftward if viewed from the observer of the image).

The internal memory 120 stores four pieces of face learning data FLD as illustrated in FIGS. 2A-2D. More specifically, the four pieces of face learning data FLD include face learning data FLD responsive to a combination of a full-faced face orientation and a face tilt of 0° (FIG. 2A), face learning data FLD responsive to a combination of a full-faced face orientation and a face tilt of 30° as (FIG. 2B), face learning data FLD responsive to a combination of a rightward looking face orientation and a face tilt of 0° (FIG. 2C), and face learning data FLD responsive to a combination of a rightward looking face orientation and a face tilt of 30° (FIG. 2D). The face at a full-faced face orientation and the face at a rightward (leftward) looking face orientation may be interpreted as two different types of subjects. In such an interpretation, the face learning data FLD may be expressed as being set depending on combinations of the types of subjects and the tilts of the subjects.

As will be described later, the face learning data FLD responsive to a given face tilt is so set through learning that an image of a face having a face tilt falling with a range of from −15° to +15° with respect to the given face tilt is detected. The human face is generally symmetrical. If two pieces of data at the full-faced face orientation, one for the face learning data FLD at a face tilt of 0° (FIG. 2A) and the other for the face learning data FLD at a face tilt of 30° (FIG. 2B), are prepared, the face learning data FLD allowing the image at any face tilt to be detected may be obtained by rotating these two pieces of face learning data FLD in steps of 90°. Similarly, if two pieces of data at the rightward looking face orientation, one for the face learning data FLD at a face tilt of 0° (FIG. 2c) and the other for the face learning data FLD at a face tilt of 30° (FIG. 2D), are prepared, the face learning data FLD allowing the image at any face tilt to be detected may be obtained by rotating these two pieces of face learning data FLD in steps of 90°. As for the leftward looking face orientation, the face learning data FLD allowing the image at any face tilt to be detected may be obtained by rotating the face learning data FLD for the rightward looking face orientation.

The part learning data OLD is set in association with a combination of a type of a part of the face and a part tilt. In accordance with the first embodiment of the invention, the face parts include the eyes (the right and left eyes) and the mouth. The part tilt means a tilt of a part of the face (angle of rotation) within the image (in-plane tilt). More specifically, the part tilt refers to an angle of rotation of the part of the face about an axis substantially perpendicular to the plane of the image. As the face tilt, the part tilt is represented by a clockwise angle of rotation of the part of the face from the reference state (with the part tilt=0). The reference state is a state in which the part of the face is positioned in a substantially vertical direction of the target image.

The internal memory 120 stores four pieces of part learning data OLD as illustrated in FIGS. 2E-2H. More specifically, the four pieces of part learning data OLD include part learning data OLD responsive to a combination of the eye and a part tilt of 0° (FIG. 2E), part learning data OLD responsive to a combination of the eye and a part tilt of 30° (FIG. 2F), part learning data OLD responsive to a combination of the mouth and a part tilt of 0° as (FIG. 2G), and part learning data OLD responsive to a combination of the mouth and a part tilt of 30° (FIG. 2H) Since the eye and the mouth are different types of subjects, the part learning data OLD may be expressed as being set depending on combinations of the types of subjects and the tilts of the subjects.

As the face learning data FLD, the part learning data OLD responsive to a given part tilt is so set through learning that an image of a part having a part tilt falling with a range of from −15° to +15° with respect to the given pat tilt is detected. The human eyes and mouth are generally symmetrical. If two pieces of data of the eye, one for the part learning data OLD at a part tilt of 0° (FIG. 2E) and the other for the part learning data OLD at a part tilt of 30° (FIG. 2F), are prepared, the part learning data OLD allowing the image at any part tilt to be detected may be obtained by rotating these two pieces of part learning data OLD in steps of 90°. Similarly, if two pieces of data of the mouth, one for the part learning data OLD at a part tilt of 0° (FIG. 2G) and the other for the part learning data OLD at a face tilt of 30° (FIG. 2H), are prepared, the part learning data OLD allowing the image at any part tilt to be detected may be obtained by rotating these two pieces of face learning data FLD in steps of 90°. In accordance with the first embodiment of the invention, the right eye and the left eye are the same type of subject, and a right-eye area for the image of the right eye and a left-eye area for the image of the left eye are thus detected using identical part learning data OLD. Alternatively, the right eye and the left eye may be handled as different subjects. The part learning data OLD for the right-eye area detection may be set to be different from the part learning data OLD for the left-eye area detection.

The internal memory 120 (FIG. 1) further stores a preset condition table CT. The condition table CT contains information that maps the mode of an image processing process to be performed to an angle of a face to be displayed in a detected face area, etc. The content of the condition table CT will be described later.

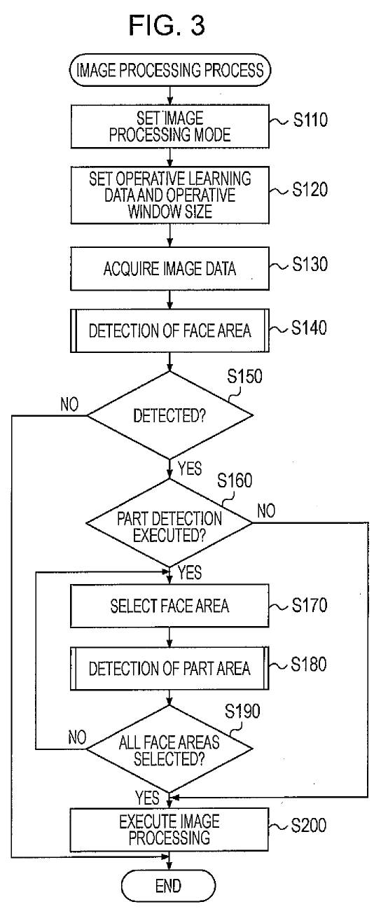

FIG. 3 is a flowchart of an image processing process in accordance with the first embodiment of the invention. In the image processing process, the mode of the image processing process is set, and the set mode of the image processing process is then executed.

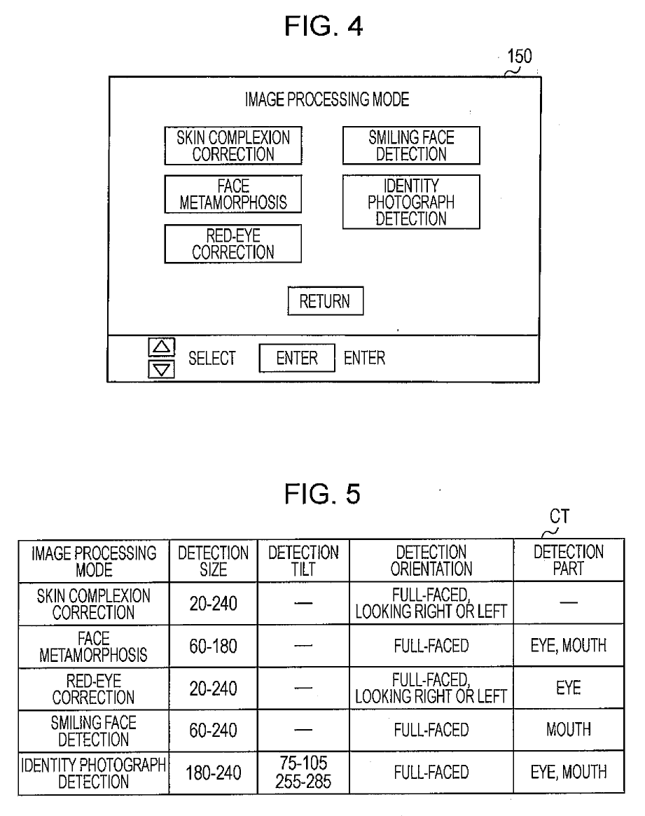

In step S110 of the image processing process, the processing mode setter 220 sets the mode of the image processing process. More specifically, the processing mode setter 220 controls the display processor 310, thereby causing a user interface to be displayed on the display unit 150 for image processing mode setting. FIG. 4 illustrates an example of a user interface for image processing mode setting. With reference to FIG. 4, the printer 100 has five image processing modes: skin complexion correction, face metamorphosis, red-eye correction, smiling face detection, and identity photograph detection.

Skin complexion correction is an image processing mode for correcting the skin complexion of a person to a favorite color. Face metamorphosis is an image processing mode for metamorphosing an image in a face area or an image in an image area containing the image of the face set in the face area. Red-eye correction is an image processing mode for correcting the color of the eye suffering for the red-eye effect to a natural color. Smiling face detection is an image processing mode for detecting an image of a face of a smiling person. Identity photograph detection is an image processing mode for detecting an image appropriate for an identity photograph.

When the user selects one of the image processing modes using the operation unit 140, the designation acquisition unit 222 acquires information identifying the image processing mode selected and designated (hereinafter referred to as “image processing mode identification information”). The processing mode setter 220 sets the image processing mode, identified by the image processing mode identification information, as the image processing mode to be executed. In the image processing mode, a predetermined process is performed on a face area (or an image area set based on the face area) detected in a face area detection process (step S140 in FIG. 3). The set image processing mode is an application of the results of the face area detection process, and the image processing mode identification information is application identification information identifying an application of the face area detection results. The designation acquisition unit 222 acquiring the image processing mode identification information thus functions as an application identification information acquisition unit.

In step S120, the condition setter 230 sets a condition related to an angle or the like of a face to be displayed in the face area detected in the face area detection process, based on the image processing mode identification information and the condition table CT. On the basis of the set condition, the condition setter 230 sets the learning data and a window size to be used.

FIG. 5 illustrates an example of the content of the condition table CT. With reference to FIG. 5, the condition table CT specifies a detection size, a detection tilt, a detection orientation, and a detection part on a per image processing mode basis.

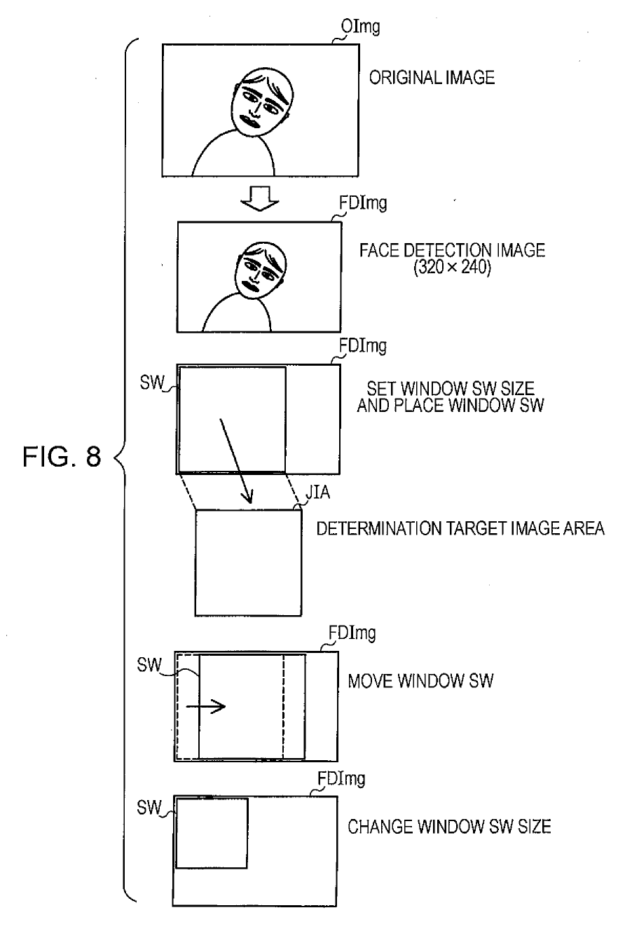

The detection tilt specified in the condition table CT is a tilt of a face to be displayed in the image area detected as a face area in an image (a face detection image FDImg (FIG. 8)) as a target of the face area detection process (step S140). Referring to FIG. 5, no detection tilt is specified for skin complexion correction, face metamorphosis, red-eye correction, and smiling face detection. This means that the image area representing the face at any tilt is to be detected as a face area. If the image processing mode is one of skin complexion correction, face metamorphosis, red-eye correction, and smiling face detection, the condition setter 230 sets all face tilts as detection tilts.

In identity photograph detection, the detection tilt is defined as a range of from −15° to +15° with respect to each of 90° and 270° (i.e., from 75° to 105° and from 255° to 285°). The detection tilt is defined because the identity photograph is typically in a portrait frame with the frame vertical sides in substantially parallel with vertical sides of the face. If the image processing mode is identity photograph detection, the condition setter 230 sets the detection tilt within a range of from −15° to +15° with respect to each of 90° and 270°.

The detection orientation specified in the condition table CT is a face orientation of a face displayed in the image area to be detected as the face area in the image (face detection image FDImg) handled as a target of the face area detection process. In skin complexion correction and red-eye correction, the detection orientations include all of the full-faced face, rightward looking and leftward looking orientations. This is because each of skin complexion correction and red-eye correction is performed regardless of the orientation of the face. If one of the image processing modes is one of skin complexion correction and red-eye correction, the condition setter 230 sets all the orientations as the detection orientation.

Only the full-faced face orientation is specified as the detection orientation in each of face metamorphosis, smiling face detection and identity photograph detection. This is because if the metamorphosis process is performed on the face that is in a rightward looking position or a leftward looking position (other than a full-faced position), the process results are likely to become unnatural. Smiling face detection and identity photograph detection are based on the premise that the full-faced face is handled as a detection target. If the image processing mode is one of face metamorphosis, smiling face detection, and identity photograph detection, the condition setter 230 sets the full-faced face orientation as the detection orientation.

The condition setter 230 sets the face learning data FLD for use in the face area detection process based on the combination of the detection tilt and the detection orientation specified in the condition table CT. More specifically, the condition setter 230 sets as the face learning data FLD in use the face learning data FLD responsive to the detection tilt and the detection orientation so that the face area responsive to the image of the face having the detection tilt and the detection orientation specified in the condition table CT is detected. More specifically, if the image processing mode is one of skin complexion correction and red-eye correction, face learning data FLD responsive to combinations of all face tilts and all face orientations is set as the learning data in use. If the image processing mode is one of face metamorphosis and smiling face detection, face learning data FLD responsive to combinations of all face tilts and the full-faced face orientation is set as the learning data in use. If the image processing mode is identity photograph detection, face learning data FLD responsive to combinations of face tilts of 90° and 270° and the full-faced face orientation is set as the learning data in use.

The detection part specified in the condition table CT is a type of the part of the face to be detected in a part area detection process (step S180 in FIG. 3) to be discussed later. Referring to FIG. 5, no detection part is specified in skin complexion correction. This means that the part area detection process is not needed. No detection part is specified in skin complexion correction because the position of the part of the face is not referenced in the execution of skin complexion correction and because high accuracy is not required of the position and tilt of the face area. The eye and the mouth detection parts are defined as the detection part in face metamorphosis and identity photograph detection. This is because the results of face metamorphosis become more natural by increasing the accuracy of the face area as a result of adjustment of the face area in accordance with detected part areas (an eye area and a face area). As for identity photograph detection, detection accuracy is increased by adjusting the face area in accordance with the detected part area. The eye is specified as the detection part in red-eye correction in order to detect a red-eyed image. The mouth is specified as the detection part in smiling face detection in order to determine a smiling face in response to the image of the mouth.

The condition setter 230 sets the detection part specified in the condition table CT as the type of a part of a face to be detected in the part area detection process. The condition setter 230 sets the part learning data OLD to be used in the part area detection process, in accordance with the detection part specified in the condition table CT. More specifically, the condition setter 230 sets as the part learning data OLD the part learning data OLD responsive to the detection part so that a part area responsive to the detection part specified in the condition table CT is detected in accordance with the set image processing mode. More specifically, if the image processing modes are face metamorphosis and identity photograph detection, the part learning data OLD for the eye and the part learning data OLD for the mouth is set as the learning data to be used. If image processing mode is red-eye correction, the part learning data OLD for the eye is set as the learning data to be used. If image processing mode is smiling face detection, the part learning data OLD for the mouth is set as the learning data to be used.

The detection size specified in the condition table CT is a size of an image area to be detected as the face area in the image (face detection image FDImg) serving as a target of the face area detection process (step S140 in FIG. 3). The condition table CT lists the detection size with the size of the face detection image FDImg being horizontal 320 pixels by vertical 240 pixels. In accordance with the first embodiment of the invention, the face area is detected as a square image area, and the detection size is defined by the number of pixels along one side of the face area.

Referring to FIG. 5, the detection size in each of skin complexion correction and red-eye correction falls within a range of 20-240 pixels. The range of the detection size covers the entire range of the face area detectable. The detection size in face metamorphosis ranges from 60-180 pixels, and excludes a relatively small size within a range of 20-60 pixels and a relatively large size within a range of 180-204 pixels. If face metamorphosis is performed on a face area having a relatively small or relatively large size in response to the face detection image FDImg, the results of the face metamorphosis may become unnatural. The above range setting avoids such unnatural results. The detection size in smiling face detection ranges from 60-240 pixels and excludes a relatively small size within a range of 20-60 pixels. This range setting prevents the detection accuracy from being lowered when smiling face detection is performed on a face area having a relatively small size in response to the face detection image FDImg. The detection size in identity photograph detection ranges from 180-240 pixels and is thus limited to a relatively large size. This is because the ratio of the size of the image of the face to the entire image size is typically large in identity photographs.

The condition setter 230 sets, as the size of the image area to be detected as the face area in the face area detection process, the detection size specified in the condition table CT. The condition setter 230 also sets an operative window size so that the face area matching the detection size specified in the condition table CT is detected. As will be described later, a square window SW is placed on the face detection image FDImg with the size and position thereof modified in the face area detection process. The face area is detected by determining whether a determination target image area JIA, as an image area on the face detection image FDImg, defined by the placed window SW, corresponds to an image area corresponding to the image of the face (see FIG. 8). The operative window size is within a range of the window SW used in the face area detection process (i.e., a range of values the determination target image area JIA takes as the size thereof).

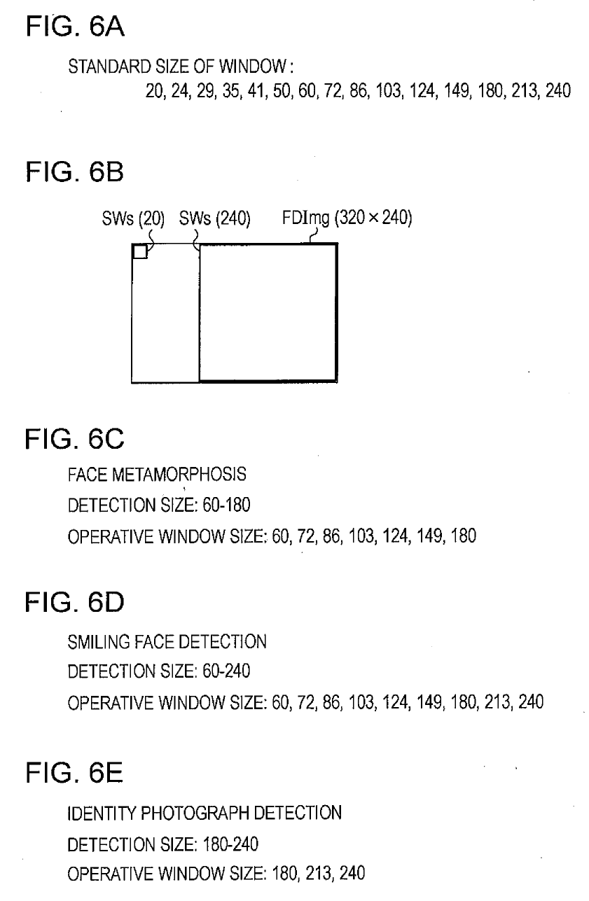

FIGS. 6A-6E illustrate a setting method of the operative window size. The condition setter 230 provides predetermined standard sizes of 15 windows SW as illustrated in FIG. 6A. More specifically, the standard sizes (length of one side) of the windows SW include a total of fifteen sizes of 20 pixels (smallest size), 24 pixels, 29 pixels, 35 pixels, 41 pixels, 50 pixels, 60 pixels, 72 pixels, 86 pixels, 103 pixels, 124 pixels, 149 pixels, 180 pixels, 213 pixels, and 240 pixels (largest size). FIG. 6B illustrates the smallest window SWs(20) and the largest window SWs(240) placed on the face detection image FDImg.

The condition setter 230 sets as the operative window size a standard size falling within the range of the detection size specified in the condition table CT out of the standard sizes of the fifteen windows. The detection size used in skin complexion correction and red-eye correction ranges from 20-240 pixels, and all the standard sizes of the 15 windows SW are set as the operative window sizes.

The detection size in face metamorphosis ranges from 60-180 pixels as illustrated in FIG. 6C. The operative window sizes are seven standard sizes of 60 pixels, 72 pixels, 86 pixels, 103 pixels, 124 pixels, 149 pixels, and 180 pixels falling within the range of the detection size. The detection size in smiling face detection ranges from 60-240 pixels as illustrated in FIG. 6D. The operative window sizes are nine standard sizes of 60 pixels, 72 pixels, 86 pixels, 103 pixels, 124 pixels, 149 pixels, 180 pixels, 213 pixels, and 240 pixels falling within the range of the detection size. The detection size in identity photograph detection ranges from 180-240 pixels as illustrated in FIG. 6E. The operative window sizes are three standard sizes of 180 pixels, 213 pixels, and 240 pixels falling within the range of the detection size.

In step S130 of the image processing process, the image processor 200 acquires image data representing an image as a target of the image processing process. The display unit 150 displays a thumbnail image of an image file stored on the memory card MC inserted in the card slot 172. The user selects at least one image to be processed using the operation unit 140 while monitoring the displayed thumbnail image. The image processor 200 acquires from the memory card MC an image file containing image data responsive to at least one image selected, and stores the image file onto a predetermined area of the internal memory 120. The acquired image data is referred to as original image data, and an image represented by the original image data is referred to as an original image OImg.

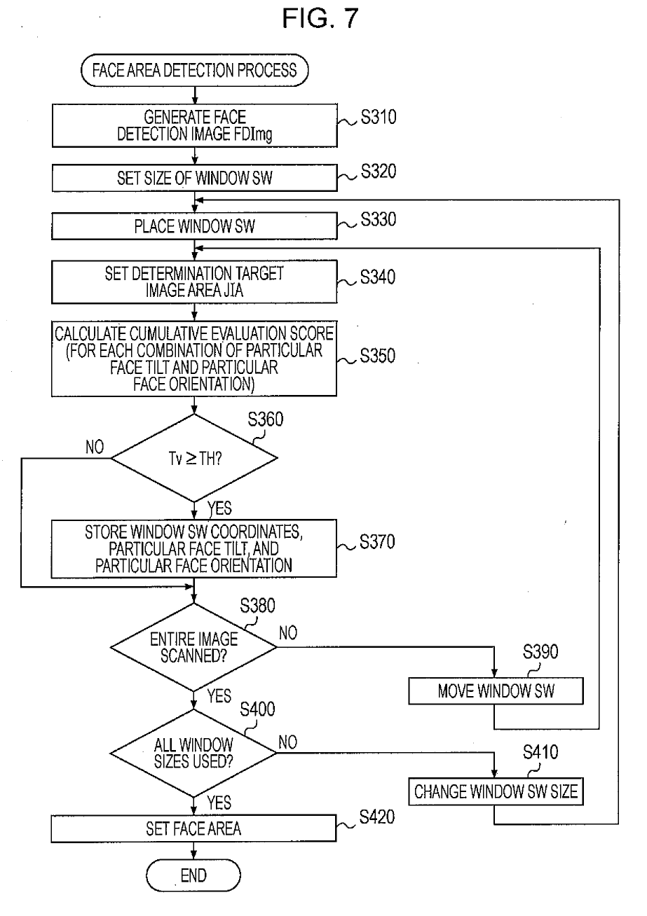

In step S140, the area detector 210 performs the face area detection process. In the face area detection process, the image area corresponding to the image of the face is detected as a face area FA. The operative learning data and the operative window size are used in the face area detection process. FIG. 7 is a flowchart of the face area detection process. FIG. 8 illustrates a summary of the face area detection process. The original image OImg is illustrated at the top portion of FIG. 8.

In step S310 of the face area detection process (FIG. 7), the area detector 210 generates face detection image data representing the face detection image FDImg from original image data representing the original image OImg. In accordance with the first embodiment of the invention, the face detection image FDImg has an image size of horizontal 320 pixels by vertical 240 pixels as shown in FIG. 8. The area detector 210 generates the face detection image data representing the face detection image FDImg by performing a resolution conversion process on the original image data as necessary.

In step S320, the determination target setter 211 sets an initial value of the size of the window SW for use in setting the determination target image area JIA (to be discussed later). In step S330, the determination target setter 211 places the window SW at an initial position on the face detection image FDImg. In step S340, the determination target setter 211 sets as the determination target image area JIA the image area defined by the window SW placed on the face detection image FDImg. The determination target image area JIA serves as a target area, i.e., a determination is made as to whether the determination target image area JIA is the face area corresponding to the image of the face. As illustrated in the middle portion of FIG. 8, the window SW having the initial size is set on the face detection image FDImg, and the image area defined by the window SW is set as the determination target image area JIA. The determination target image area JIA is successively set with the size and position of the square window SW changed as described below. The initial value of the size of the window SW is the largest size of the operative window sizes set in step S120 (FIG. 3), and the window SW is placed at the initial position thereof with the upper left corner thereof placed on the upper left corner of the face detection image FDImg. If the image processing mode to be executed is the skin complexion correction, the initial value of the size of the window SW is 240 pixels (see FIG. 6A). If the image processing mode to be executed is the face metamorphosis, the initial value of the size of the window SW is 180 pixels (see FIG. 6C). The window SW is placed with the tilt thereof being 0°. As previously discussed, the tilt of the window SW refers to an angle of clockwise rotation of the window SW from the reference state (tilt=0°). The reference state is a state in which the upward looking direction of the window SW is aligned with the upward looking direction of the target image (the face detection image FDImg).

In step S350, the evaluation score calculator 212 calculates a cumulative evaluation score Tv for use in the face determination in the determination target image area JIA on the basis of the image data of the determination target image area JIA. The face determination is performed based on each combination responsive to the image processing mode to be performed, out of the predetermined combinations of particular face tilts and particular face orientations, using the operative learning data set in step S120. More specifically, it is determined for each combination responsive to the image processing process to be performed whether the determination target image area JIA is the face area responsive to the image of the face having the particular face tilt and the particular face orientation. For this reason, the cumulative evaluation score Tv is also calculated for each of the combinations of particular face tilt and particular face orientations responsive to the image processing process to be performed. The particular face tilt means a specific face tilt. In accordance with the first embodiment, there are twelve particular face tilts including a reference face tilt (face tilt=0 degrees), and eleven other face tilts increasing in steps of 30 degrees (30°, 60°, . . . , 330°). The predetermined face orientation is a specific face orientation. In accordance with the first embodiment of the invention, there are three predetermined face orientations, i.e., the full-faced face orientation, the rightward looking orientation, and the leftward looking orientation.

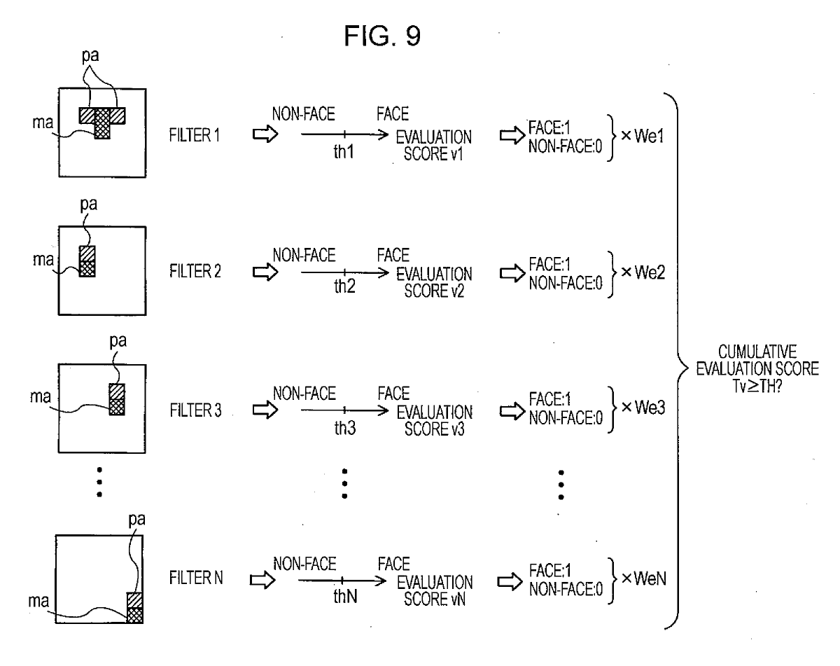

FIG. 9 illustrates a calculation method of the cumulative evaluation score Tv for use in the face determination. N filters 1-N are used in the calculation of the cumulative evaluation score Tv. Each filter has an external outline identical in aspect ratio to the window SW (i.e., a square shape) and a positive region pa and a negative region ma. The evaluation score calculator 212 calculates an evaluation score vX (i.e., v1-vN) by successively applying the filters X (X=1, 2, . . . , N) to the determination target image area JIA. More specifically, the evaluation score vX is determined by subtracting the sum of luminance values of pixels present in the determination target image area JIA corresponding to the negative region ma of the filter X from the sum of luminance values of pixels present in the determination target image area JIA corresponding to the positive region pa of the filter X.

The calculated evaluation score vX is compared with a threshold value thX set for each evaluation score vX (i.e., th1-thN). If the evaluation score vX is equal to or higher than the threshold value thX, it is determined that the determination target image area JIA is the image area corresponding to the image of the face with respect to the filter X, and a value “1” is set for the output value for the filter X. If the evaluation score vX is lower than the threshold value thX, it is determined that the determination target image area JIA is not the image area corresponding to the image of the face with respect to the filter X, and a value “0” is set for the output value for the filter X. Weight coefficients Wex (i.e., We1-WeN) are set respectively for the filters X. The sum of products of the outputs of each filter X and the respective weights Wex is calculated as the cumulative evaluation score Tv.

The specifications of each filter X, the threshold value thX, the weight coefficient Wex, and a threshold value TH are specified in the face learning data FLD. For example, the specifications of each filter X, the threshold value thX, the weight coefficient Wex, and the threshold value TH, specified in the face learning data FLD responsive to a combination of the full-faced face orientation and a face tilt of 0° (see FIG. 2A), are used for the calculation of the cumulative evaluation score Tv and the face determination responsive to a combination of the full-faced face orientation and a face tilt of 0°. Similarly, the face learning data FLD responsive to the combination of the full-faced face orientation and a face tilt of 30° (see FIG. 2B) is used for the calculation of the cumulative evaluation score Tv and the face determination responsive to the combination of the full-faced face orientation and a face tilt of 30°. The calculation of the cumulative evaluation score Tv and the face determination responsive to the combination of the full-faced face orientation and another face tilt may be performed. In this case, the evaluation score calculator 212 generates and uses the face learning data FLD responsive to the combination of the full-faced face orientation and the other face tilt based on the face learning data FLD responsive to a combination of the full-faced face orientation and a face tilt of 0° (see FIG. 2A) and the face learning data FLD responsive to the combination of the full-faced face orientation and a face tilt of 30° (see FIG. 2B). Similarly, the evaluation score calculator 212 generates and uses the face learning data FLD for the rightward looking face orientation and the leftward looking face orientation based on the face learning data FLD stored beforehand on the internal memory 120. The face learning data FLD is data that is used to calculate an evaluation score indicating the likelihood that the determination target image area JIA is the image area corresponding to the image of the face. The face learning data FLD thus corresponds to the evaluation data. The face learning data FLD is preset in response to values set as the detection tilt and the detection orientation (see FIG. 5).

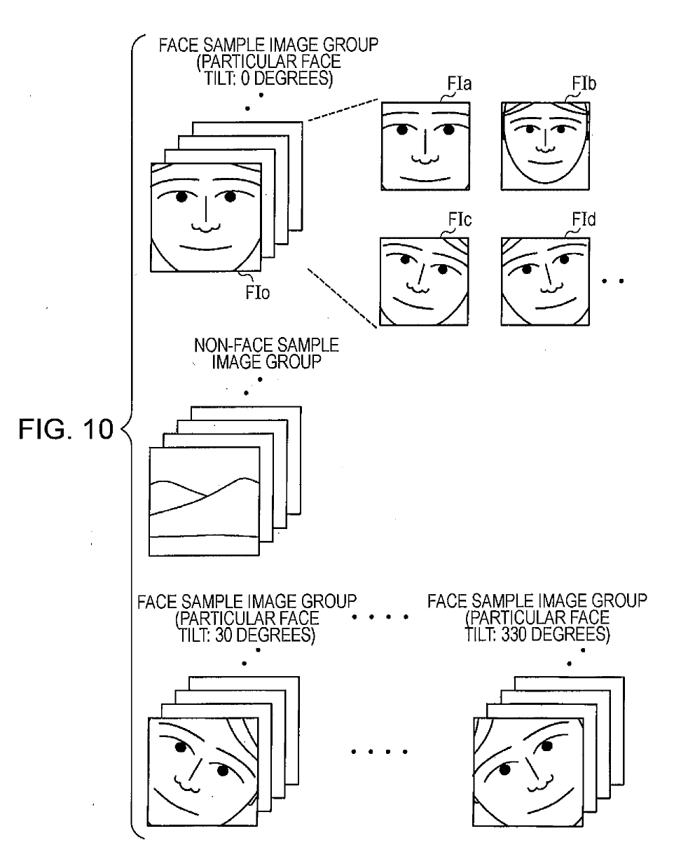

The face learning data FLD is set through a learning process of a sample image. FIG. 10 illustrates an example of a sample image that is used in the learning process for setting the face learning data FLD responsive to the full-faced face. The learning process uses a face sample image group composed of a plurality of face sample images known beforehand as images responsive to the full-faced face and a non-face sample image group composed of a plurality of non-face sample images known beforehand as images not responsive to the full-faced face.

The face sample image group includes images of faces having twelve particular face tilts as shown in FIG. 10 so that the setting of the face learning data FLD responsive to the full-faced face through the learning process is performed on a per particular face tilt basis. For example, the face learning data FLD responsive to a particular tilt face of O is set using a face sample image group responsive to the face tilt of 0° and a non-face sample image group. The face learning data FLD responsive to a particular face tilt of 30° is set using a face sample image group responsive to a particular face tilt of 30° and a non-face sample image group.

The face sample image group responsive to each particular face tilt includes a plurality of face sample images, each face sample image having within a predetermined range a ratio of a size of the image of the face to the image size and the tilt of the image of the face equal to a particular face tilt (hereinafter referred to as a “reference face sample image FIo”). The face sample image group includes at least an image that is obtained by scale-expanding or scale-contracting the reference face sample image FIo within a range of 1.2-0.8 times (such as one of images FIa and FIb in FIG. 10), and an image that is obtained by varying the reference face sample image FIo in face tilt within a range of −15° to +15° (such as one of images FIc and FId in FIG. 10).

The learning process using the sample image is performed using a method of a neural network, a method of boosting (such as AdaBoosting), or a method of using a support vector machine. If the learning process is performed using a neural network, the evaluation score vX (vX1-vN) is calculated with respect to each filter 1-N (FIG. 9) using all the sample images contained in the face sample image group responsive to a particular face tilt and the non-face sample image group, and a predetermined threshold value thX (th1-thN) that accomplishes a predetermined face detection rate is set. The face detection rate means a ratio of the number of face sample images that are determined as an image responsive to the image of the face through a threshold determination of the evaluation score vX to the total number of face sample images forming the face sample image group.

An initial value is set for the weight coefficient Wex (We1-WeN) for the filter X, and the cumulative evaluation score Tv is calculated for one sample image selected from the face sample image group and the non-face sample image group. As will be discussed later, the image is determined as the image corresponding to the image of the face if it is determined in the face determination that the cumulative evaluation score Tv calculated for the image is equal to or higher than the predetermined threshold value TH. The weight coefficient Wex set for each filter X is modified in response to the threshold value determination results of the cumulative evaluation score Tv calculated for the selected sample image (one of the face sample image and the non-face sample image). The selection of the sample image, the threshold value determination based on the cumulative evaluation score Tv calculated for the selected sample image, and the modification of the weight coefficient Wex based on the threshold value determination are repeated for all the sample images contained in the face and non-face sample image groups. Through this process, the face learning data FLD responsive to the combination of the full-faced face orientation and the particular face tilt is set.

Similarly, the face learning data FLD responsive to the other particular face orientation (the rightward looking face and the leftward looking face) is also set through the learning process. The learning process uses a face sample image group composed of a plurality of face sample images known beforehand as images responsive to the other particular face orientation (the rightward looking orientation and the leftward looking orientation) and a non-face sample image group composed a plurality of non-face sample images known beforehand as images not responsive to the rightward looking face (or the leftward looking face).

If the image processing mode is one of skin complexion correction and red-eye correction, face learning data FLD responsive to the combinations of all the particular face orientations and all the particular face tilts is set as operative learning data. The cumulative evaluation score Tv based on the face learning data FLD is thus calculated. Similarly, if the image processing mode is one of face metamorphosis and smiling face detection, face learning data FLD responsive to the combinations of all the particular face orientations and all the particular face tilts is used to calculate the cumulative evaluation score Tv. If the image processing mode is identity photograph detection, the face learning data FLD responsive to the combinations of the particular face tilts of 90° and 270° and the full-faced face orientation is used to calculate the cumulative evaluation score Tv.

When the cumulative evaluation score Tv is calculated for each combination of a particular face orientation and tilt in the determination target image area JIA (step S350 in FIG. 7), the determiner 213 compares the cumulative evaluation score Tv with the threshold value TH set for each combination of a particular face orientation and tilt (step S360). If the cumulative evaluation score Tv is equal to or higher than the threshold value TH in connection with one combination of a particular face orientation and tilt, the area detector 210 determines that the determination target image area JIA is the image area corresponding to the image of the face having the particular face orientation and tilt. The area detector 210 thus stores the position of the determination target image area JIA, i.e., coordinates of the currently set window SW, and the particular face orientation and tilt (step S370). If the cumulative evaluation score Tv is lower than the threshold value TH in each of the combinations of particular face orientations and particular face tilts, the process step in S370 is skipped.

In step S380, the area detector 210 determines whether the entire face detection image FDImg is scanned with currently set window SW. If the entire face detection image FDImg is not scanned with currently set window SW, the determination target setter 211 moves the window SW by a predetermined distance in a predetermined direction (step S390). FIG. 8 illustrates in the lower portion thereof the moved window SW. In accordance with the first embodiment of the invention, the window SW is moved rightward by a distance equal to 20% of the horizontal size of the window SW in step S390. If the window SW is placed at the position from which no further rightward movement is permitted, the window SW is moved back to the left edge of the face detection image FDImg in step S390, and then moved downward by a distance equal to 20% of the vertical size of the window SW. If the window SW is placed at the position from which no further downward movement is permitted, the entire face detection image FDImg has now been scanned. After the movement of the window SW (step S390), step S340 and subsequent steps are performed on the moved window SW.

If it is determined in step S380 (FIG. 7) that the entire face detection image FDImg has been scanned, it is then determined whether all the operative window sizes set in step S120 (FIG. 3) have been used (step S400). If an unused operative window size remains, the determination target setter 211 modifies the size of the window SW to the next smallest size from the currently set operative window size (step S410). In other words, the largest window size is first used, and then a smaller window size is successively used. After the change of the window size (step S410), step S330 and subsequent steps are performed on the size changed window SW.

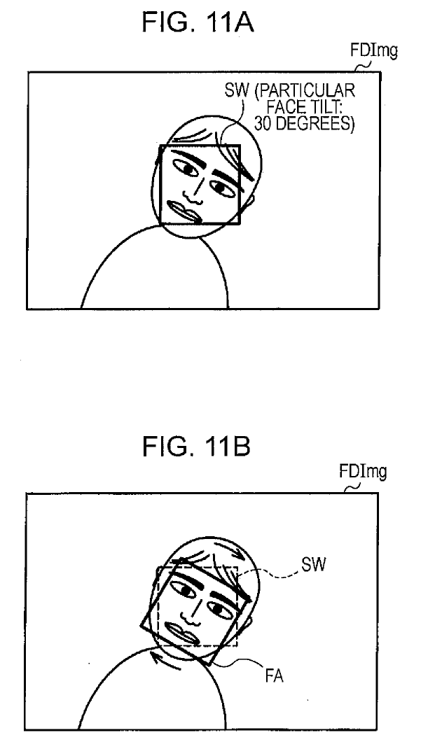

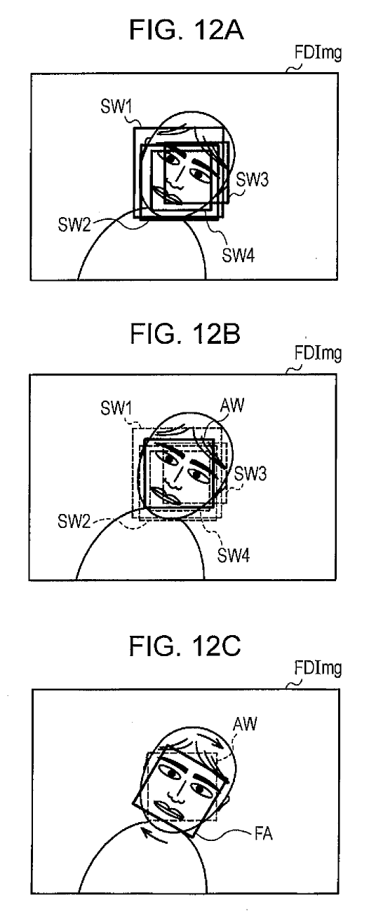

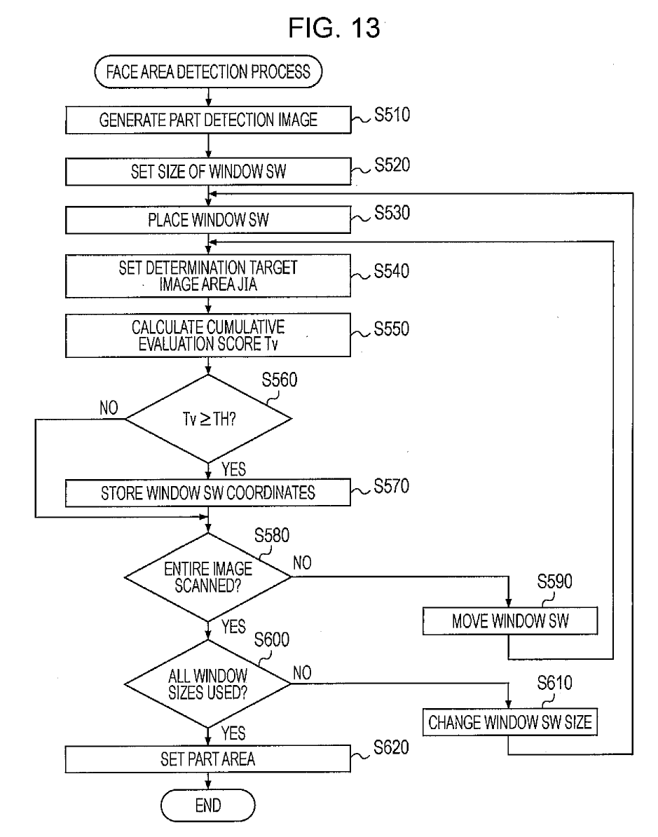

If all the operative window sizes set in step S120 have been used, the area setter 214 executes a face area setting process (step S420). FIGS. 11A and 11B and 12A-12C diagrammatically illustrate the face area setting process. When it is determined in step S360 of FIG. 7 that the cumulative evaluation score Tv is equal to or higher than the threshold value TH, the area setter 214 sets the face area FA as the image area corresponding to the image of the face based on the coordinates of the window SW (i.e., the position and the size of the window SW) and the particular face tilt stored in step S370. More specifically, if the stored particular face tilt is 0°, the image area specified by the window SW (i.e., the determination target image area JIA) is set as the face area FA as is. On the other hand, if the stored particular face tilt is other than 0°, the tilt of the window SW is set to be equal to the predetermined face tilt. More specifically, the window SW is rotated clockwise about a predetermined point thereof (the center of gravity of the window SW, for example) to the face tilt by the corresponding angle of rotation. The image area specified by the rotated window SW is set as the face area PA. For example, if the cumulative evaluation score Tv is equal to or higher than the threshold value TH with respect to a face tilt of 30° as illustrated in FIG. 11A, the tilt of the window SW is rotated to 30° and the image area specified by the rotated window SW is set as the face area FA.

A plurality of windows SW mutually overlapping each other at a given particular face tilt may be stored in step S370. In such a case, the area setter 214 sets a new window SW having as the center of gravity thereof the average of the coordinates of predetermined points (centers of gravity) of the windows SW and the average size of the sizes of the windows SW. Such a new window SW is referred to as an “average window AW.” If four windows SW1-SW4 mutually overlapping each other are stored as illustrated in FIG. 12A, the average window AW having the average coordinates of the four windows SW as the center of gravity thereof and the average size of the four windows SW as the size thereof is defined as illustrated in FIG. 12B. As previously discussed, if the stored particular face tilt is 0°, the image area specified by the average window AW is set as the face area FA as is. If the stored particular face tilt is other than 0°, the tilt of the average window AW is set to equal to the tilt of the particular face tilt. More specifically, the average window AW is rotated clockwise about a predetermined point thereof (the center of gravity of the average window AW, for example) to the face tilt by the corresponding angle of rotation. The image area specified by the rotated average window AW is set as the face area FA (see FIG. 12C).

A single window SW having no overlapping portion with another window SW, as illustrated in FIGS. 11A and 11B, may be interpreted as the average window AW in the same manner as illustrated in FIGS. 12A-12C where the plurality of windows SW mutually overlapping each other are stored.

In accordance with the first embodiment, the face sample image group (see FIG. 10) used in the learning process includes the image that is obtained by scale-expanding or scale-contracting the reference face sample image FIo within a range of 1.2-0.8 times (such as one of images FIa and FIb in FIG. 10). Even if the ratio of the image of the face to the size of the window SW is slightly smaller than or slightly larger than that of the reference face sample image FIo, the face area FA can be detected. Although fifteen discrete sizes are set as the standard sizes of the window SW in accordance with the first embodiment, the face area FA can be set for the image of the face of any size falling with the range of set detection size (FIG. 5). Similarly, the face sample image group (see FIG. 10) used in the learning process includes the image that is obtained by varying the reference face sample image FIo in face tilt within a range of from −15° to +15° (such as one of images FIc and FId in FIG. 10). Even if the tilt of the image of the face to the tilt of the window SW is slightly different from that of the reference face sample image FIo, the face area FA can be detected. Although the fifteen discrete tilt values are set as the standard face tilts of the window SW in accordance with the first embodiment, the face area FA can be set for the image of the face of any tilt falling with the range of detection tilt (FIG. 5).

If the face area FA is not detected in the face area detection process (step S140 of FIG. 3) (NO in step S150), the image processing process ends. If at least one face area FA is detected (YES in step S150), the image processor 200 determines whether to perform the part area detection process (step S160). If the image processing mode set in step S110 is skin complexion correction, the part area detection process is determined as being unnecessary (NO in step S160) because the detection part is not specified in the condition table CT. In such a case, the part area detection process (step S180) is skipped, and processing proceeds to step S200.

If the image processing mode set in step S110 is other than skin complexion correction, a detection part is specified in the condition table CT. It is thus determined in step S160 that the part area detection process is to be performed (YES in step S160). Processing proceeds to step S170 where the area detector 210 selects one detected face area FA.

In step S180, the area detector 210 performs the part area detection process. In the part area detection process, the image area corresponding to the image of a part of the face in the selected face area FA is detected as a part area. In response to the image processing mode set in step S110, the area detector 210 detects a part corresponding to the detected part associated with image processing mode in the condition table CT. For example, if the image processing mode is red-eye correction, the area detector 210 detects a right-eye area EA(r) for the image of the right eye and a left-eye area EA(l) for the image of the left eye. If the image processing mode is smiling face detection, the area detector 210 detects a mouth area MA for the image of the mouth.

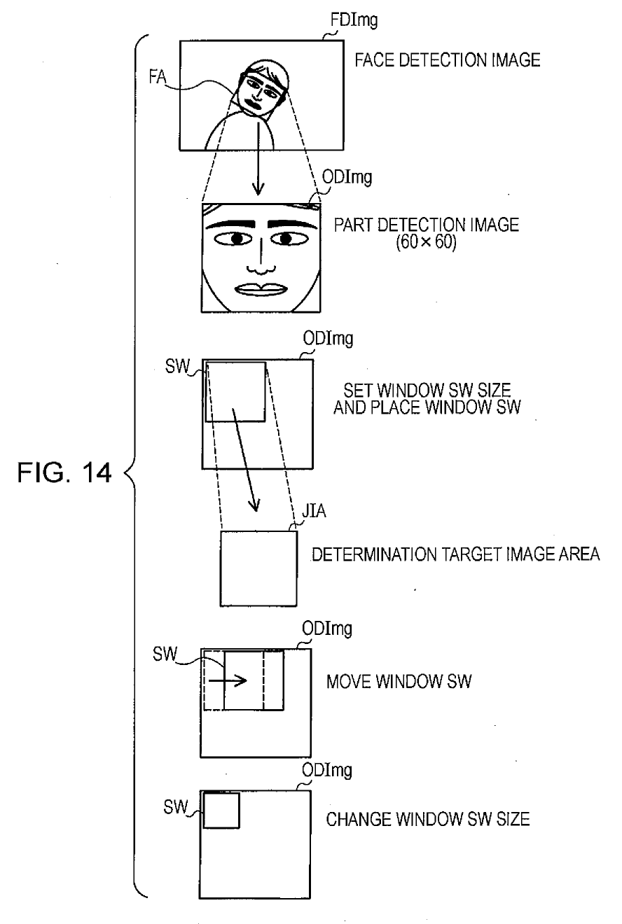

FIG. 13 is a flowchart of the part area detection process. FIG. 14 diagrammatically illustrates the part area detection process. Illustrated in the top portion of FIG. 14 is the face area FA on the face detection image FDImg detected in the face area detection process.

In step S510 of the part area detection process (FIG. 13), the area detector 210 generates part detection image data representing a part detection image ODImg from the face detection image data representing the face detection image FDImg. The part detection image ODImg corresponds to the face area FA in the face detection image FDImg as illustrated in FIG. 14, and has an image size of horizontal 60 pixels by vertical 60 pixels. The area detector 210 performs trimming, affine transform, or resolution conversion on the face detection image data as necessary, thereby generating the part detection image data representing the part detection image ODImg.

The detection of the part area from the part detection image ODImg may be performed in the same manner as the detection of the face area FA from the face detection image FDImg. More specifically, as illustrated in FIG. 14, a rectangular window SW is placed on the part detection image ODImg with the size and position changed (steps S520, S530, S580-S610 in FIG. 13). The image area defined by the placed window SW is set as the determination target image area JIA (step S540) so that a part determination of whether the determination target image area JIA is a part area corresponding to the image of a part of a face is performed (hereinafter referred to as a part determination). The cumulative evaluation score Tv for use in the part determination is calculated on a per detection part basis (step S550) with respect to the determination target image area JIA using the part learning data OLD. The part learning data OLD defines the specifications, the threshold value thX, the weight coefficient Wex, and the threshold value TH (see FIG. 9) of each filter X for use in the calculation of the cumulative evaluation score Tv and the part determination. The learning process for setting the part learning data OLD is performed in the same manner as the setting of the face learning data FLD. More specifically, the learning process is performed using a part sample image group composed of a plurality of part sample images known beforehand as including an image of a part of a face and a non-part sample image group composed a plurality of non-part sample images known beforehand as including no image of a part of a face.

The cumulative evaluation score Tv is calculated at each particular face tilt in the part area detection process (step S140 of FIG. 3). In the part detection image data, however, only a single cumulative evaluation score Tv for a tilt of 0° is calculated for a single determination target image area JIA, and the part determination is performed on the image of the part at a tilt of 0°. This is because the tilt of the part of the face is generally considered as matching the tilt of the entire face. Alternatively, the cumulative evaluation score Tv may be calculated at each tilt in the part area detection process and the part determination may be performed at each tilt.

If the cumulative evaluation score Tv calculated at each detection part is equal to or higher than the threshold value TH, the determination target image area JIA is the image area corresponding to the image of the part. The position of the determination target image area JIA, i.e., the coordinates of the currently set window SW are stored (step S570 in FIG. 13). If the cumulative evaluation score Tv is lower than the threshold value TH, step S570 is skipped. After the entire part detection image ODImg is scanned with the window SW (with each of the sizes thereof), a part area setting process is performed (step S620 in FIG. 13). As the face area setting process (see FIG. 7), the part area setting process is performed by setting the average window AW, and by setting the image area defined by the average window AW as a part area.

In step S190 (FIG. 3), the area detector 210 (FIG. 1) determines whether a face area FA not yet selected in step S170 is present. If a face area FA not yet selected is present (NO in step S190), processing returns to step S170 where one of the unselected face areas FA is selected. Step S180 and subsequent steps are then performed. If all the face areas FA have been selected (YES in step S190), processing proceeds to step S200.

In step S200, the image processor 200 executes the image processing mode set in step S110. More specifically, if the image processing mode is skin complexion correction, the skin complexion of a person in the face area FA or in the image area containing the image of the face set in accordance with the face area FA is corrected to a preferable complexion. If the image processing mode is face metamorphosis, the face area FA is adjusted based on the positional relationship of the detected part area (the right-eye area EA(r), the left-eye area EA(l) and the mouth area MA), and the image within the adjusted face area FA or the image within the image area containing the image of the face set in accordance with the adjusted face area FA is metamorphosed. If the image processing mode is red-eye correction, a red-eye image is detected from the part area (the right-eye area EA(r) and the left-eye area EA(l)) detected in the face area FA and is then adjusted to be closer to a natural eye color. If the image processing mode is smiling face detection, an outline of the detected face area FA or an outline of the detected part area (mouth area MA) is detected. A smiling face determination of whether the image within the face area FA is the image of a smiling face is performed by evaluating the opening of the corner of the mouth. Techniques on smiling face determination are disclosed in JP-A-2004-178593 and the paper entitled “A Study For Moving Object Tracking In Scene Changing Environment” authored by Yoshitaka SOEJIMA, Feb. 15, 1998, Japan Advanced Institute of Science and Technology (JAIST). If the image processing mode is identity photograph detection, the face area FA is adjusted based on the positional relationship of the detected part area (the right-eye area EA(r), the left-eye area EA(l) and the mouth area MA), and it is then determined whether the target image is an identity photograph.

In the image processing process of the printer 100, information identifying the image processing mode as an application of the face area detection is acquired. The condition related to the angle of the face to be displayed in the face area FA is set based on the acquired information. The face area FA corresponding to the image of the face matching the set condition is detected in accordance with the image data representing the target image. In the face area detection process (step S140 in FIG. 3), the face learning data FLD to be used in response to the image processing mode is set. The face determination for detecting the face area FA corresponding to the image of the face satisfying the condition of the face angle (more specifically, the detection tilt and the detection orientation) is executed using only the set face learning data FLD. The face determination for detecting the face area FA corresponding to the image of the face not satisfying the condition is not executed. The printer 100 performs the face area detection process in the image at a high speed in the image processing process.

### Second Embodiment

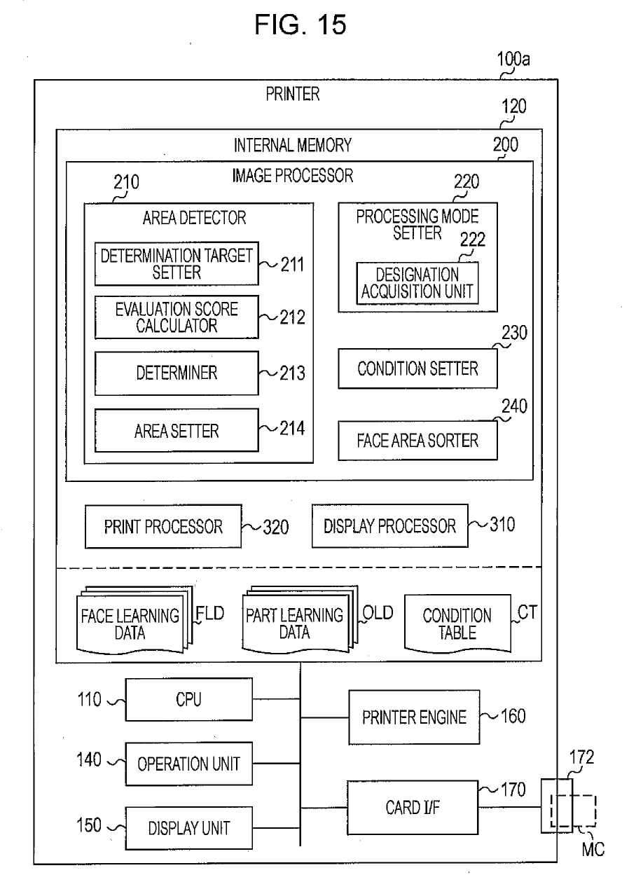

FIG. 15 diagrammatically illustrates a printer 100a as an image processing apparatus in accordance with a second embodiment of the invention. The printer 100a of the second embodiment is different from the printer 100 of the first embodiment illustrated in FIG. 1 in that the image processor 200 includes a face area sorter 240. The rest of the printer 100a is identical in structure to the printer 100 of the first embodiment.

The face area sorter 240 sorts the face areas FA into matching face areas FAf and unmatching face areas FAn. The matching face area FAf corresponds to the image of the face satisfying the condition of the detection size, the detection tilt, and the detection orientation defined according to the image processing mode to be performed in the condition table CT. The unmatching face area FAn corresponds to the image of the face not satisfying the condition.

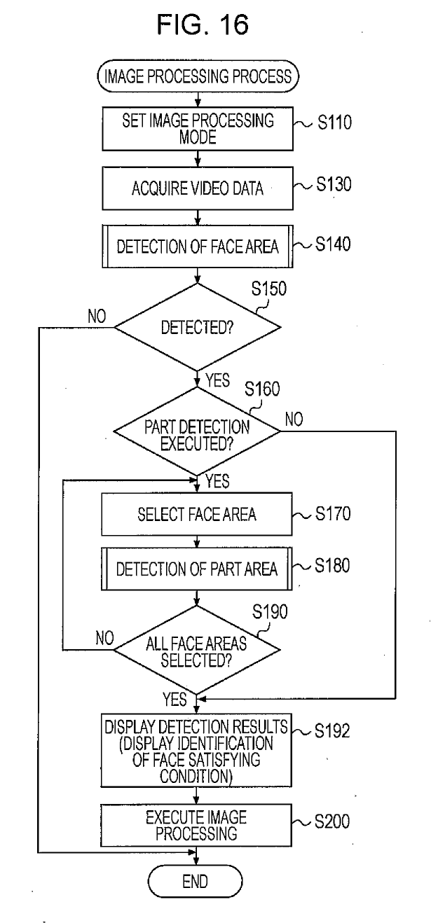

FIG. 16 is a flowchart of an image processing process in accordance with the second embodiment of the invention. As the image processing process of the first embodiment illustrated in FIG. 3, the image processing process of the second embodiment includes setting the image processing mode to be performed and performing the set image processing process.

The process content in step S110 of the image processing process (FIG. 16) is identical to the process content in step S110 (setting the image processing mode to be performed) of the image processing process of the first embodiment (FIG. 3). In the image processing process of the second embodiment, the face area detection process does not include the setting of the condition related to the angle of the face to be detected as the face area FA, and the setting of the operative learning data and the operative window size (step S120 in FIG. 3) on the basis of set condition. More specifically, in the image processing process of the second embodiment, all usable learning data and window sizes are used in the face area detection process regardless of the image processing mode set in step S110, and all detectable face areas FA are detected.

The process content in steps S130-S190 in the image processing process (FIG. 16) of the second embodiment is identical to the process content in steps S130-S190 the image processing process of the first embodiment (FIG. 3) except that the condition related to the angle and the like of the image of the face to be detected as the face area FA in the face area detection process is not set. More specifically, the process content in steps S130-S190 in the image processing process (FIG. 16) of the second embodiment is not affected by the image processing mode to be performed set in step S110.

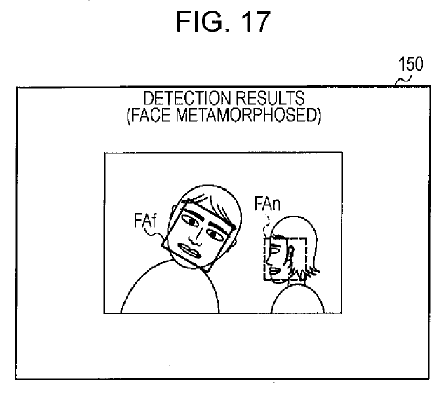

In step S192 of the image processing process (FIG. 16) of the second embodiment, the image processor 200 (FIG. 1) controls the display processor 310, thereby causing the display unit 150 to display the face area detection process results thereon. FIG. 17 illustrates an example of the face area detection results obtained when the face metamorphosis is set as the image processing mode in step S110. The face area detection process detects two face areas FA from the target image as illustrated in FIG. 17.

In the displaying of the face area detection results, the face area sorter 240 (FIG. 15) sorts the detected face areas FA into the matching face area FAf and the unmatching face area FAn. The sorting of the face areas FA is performed according to the size of the face area FA and the face tilt and face orientation responsive to the face learning data FLD used in the detection of the face area FA. More specifically, if the face learning data FLD used in the detection of the face area FA corresponds to the combination of a face tilt of 30° and the full-faced face orientation, the sorting is performed in accordance with the detection tilt and the detection orientation mapped to the face metamorphosis by the condition table CT. In this case, if the size of the detected face area FA falls within the range of detection size mapped to the face metamorphosis according to the condition table CT, the face area FA is then determined to be a matching face area FAf. If the size of the detected face area FA falls outside the range of detection size, the face area FA is determined to be an unmatching face area FAn. For example, if the face learning data FLD used in the detection of the face area FA corresponds to the combination of a face tilt of 0° and the rightward looking face orientation, the face area FA fails to match the detection tilt and the detection orientation mapped to the face metamorphosis by the condition table CT. In this case, the detected face area FA is an unmatching face area FAn.

As illustrated in FIG. 17, the image processor 200 causes the display unit 150 to display the face areas FA in response to the sorting results of the face areas FA by the face area sorter 240 so that the face areas FA are identified as to whether the face area FA is a matching face area FAf or an unmatching face area FAn. Referring to FIG. 17, the matching face area FAf is identified in position by a solid line and the unmatching face area FAn is identified in position by a broken line on the display unit 150. Since the detection orientation mapped to the face metamorphosis is only the full-faced face orientation (see FIG. 5), the face area FA corresponding to the image of the rightward looking face is identified in position as the unmatching face area FAn by the broken line.

As in the first embodiment, the image processing mode set in step S110 is performed subsequent to the displaying of the face area detection results (step S192 in FIG. 16) in the second embodiment of the invention. In accordance with the second embodiment, the image processing process is performed on only the matching face area FAf.

In the image processing process of the printer 100a as described above, the face area FA is detected from the target image. The face areas FA are sorted into the matching face area FAf and the unmatching face area FAn. The face areas FA are then displayed on the display unit 150 in a manner such that the matching face area FAf is distinctively identified from the unmatching face area FAn. In the image processing process, the printer 100a of the second embodiment causes the detected face area FA to be determined as to whether the face area FA matches the application of the face area FA.

The invention is not limited to the above-described embodiments. Changes and modifications are possible without departing from the scope of the invention. For example, the following modifications may be performed.

### First Modification

The image processing modes (FIG. 4) in the above-described embodiments are described for exemplary purposes only. The printer 100 may have another image processing mode. It is perfectly acceptable if the printer 100 lacks some of the image processing modes. For example, the printer 100 may have as an image processing mode a determination mode for determining the expression on the face other than smiling face detection. The printer 100 may have a detection mode of the image of the face having the particular tile and size other than those of identity photograph detection.

The detection size, the detection tilt, the detection orientation, and the detection part defined in accordance with the image processing mode in the condition table CT (FIG. 5) have been described for exemplary purposes only. It is not necessary that all of the detection size, tilt, orientation and part be specified in the condition table CT. It is perfectly acceptable that at least one of the detection size, tilt, orientation and part is specified.

### Second Modification

The image processing mode to be performed is set by the user. Alternatively, the image processing mode may be automatically set. The detection size, tilt, orientation and part in the face area and part area detection processes are set in accordance with the image processing mode. Alternatively, the detection size, tilt, orientation and part may be set directly by the user or automatically.

### Third Modification

The image processing apparatus is the printer 100 in the above-described embodiments. The invention is also applicable to an imaging apparatus such as a digital still camera or a digital video camera. When the invention is applied to an imaging apparatus such as a digital still camera or a digital video camera, the application of the face area detection results may be the setting of an image capturing timing. In other words, the condition relating to at least one of the detection size, tilt, orientation and part is set as in the condition table CT. If a face area satisfying the set condition is detected in a preparation image generated at the moment an image capturing button is pressed, image capturing is automatically performed, or an image capturing instruction is issued by pressing fully the image capturing button.

### Fourth Modification

In the above-described embodiments, the part detection image ODImg is generated and the determination target image area JIA is set up with the window SW placed on the generated part detection image ODImg. The part detection image ODImg is not necessarily generated, and the determination target image area JIA is set up with the window SW placed on the face detection image FDImg. In such a case, the cumulative evaluation score Tv may be calculated using the part learning data OLD responsive to the same tilt as the tilt of detected face area FA. Conversely, it the part detection image ODImg is generated, the cumulative evaluation score Tv can be calculated using only the part learning data OLD responsive to a tilt of 0°. It suffices if only the part learning data OLD responsive to a tilt of 0° is stored on the internal memory 120.

### Fifth Modification

In accordance with the first embodiment of the invention, the condition (see FIG. 5) of the face area FA to be detected is set in response to the set image processing mode, and only the face area FA satisfying the condition is to be detected. All the face areas FA may be detected regardless of whether the condition is satisfied, and only the face area FA satisfying the condition may be extracted after detection.

### Sixth Modification

The display format of the matching face area FAf and the unmatching face area FAn on the display unit 150 in accordance with the second embodiment are illustrated for exemplary purposes only. A different display format is perfectly acceptable as long as the matching face area FAf is clearly distinguished from the unmatching face area FAn. For example, the matching face area FAf and the unmatching face area FAn may be displayed within regions or within outlines of the regions, with the regions and the outlines of the regions distinguished by color difference. One of the matching face area FAf and the unmatching face area FAn may be flashed in display for distinction. Either or both of the matching face area FAf and the unmatching face area FAn may be labeled with characters or symbols for distinction.

### Seventh Modification

In the above-described embodiments, the face area detection process (FIG. 3) and the part area detection process (FIG. 13) have been discussed for exemplary purposes only. A variety of changes are possible to the processes. For example, the size of the face detection image FDImg (see FIG. 8) is not limited to 320 pixels by 240 pixels. A different size may be used. The original image OImg may be used as the face detection image FDImg. The size of the operative window SW and the movement direction and the distance (movement pitch) of the operative window SW are not limited to those described above. In each of the above-described embodiments, the face detection image FDImg is fixed to a constant size, and the determination target image area JIA is set with the window SW having one of a plurality of sizes placed on the face detection image FDImg. Alternatively, a plurality of face detection images FDImg different in size may be generated, and a plurality of determination target image areas JIA different in size may be set with the window SW having the fixed size placed on the face detection image FDImg.

In accordance with the above-described embodiments, the face and part determinations are performed by comparing the cumulative evaluation score Tv with the threshold value TH (see FIG. 9). The face and part determinations may be performed using a plurality of determiners. The learning process used in the setting of the face learning data FLD and-the part learning data OLD may also be modified in accordance with the method of the face and part determinations. The face and part determinations are not necessarily performed using the learning process. Another method such as pattern matching may be used.

In the above-described embodiments, twelve particular face tilts are set in steps of 30°. Face tilts of more than or less than twelve may be set. The particular face tilts are not necessarily set. The face determination may be performed at a face tilt of 0°. In the above-described embodiments, the face sample image group includes image obtained by scale-contracting and scale-expanding the reference face sample image FIo and image obtained by rotating the reference face sample image FIo. The face sample image group does not necessarily include such images.

In the above-described embodiments, the determination target image area JIA may be determined as corresponding to the image of the face (the image of the part of the face) in the face determination (the part determination) in the determination target image area JIA specified by the window SW of a given size. When the window SW having a size smaller than a predetermined rate than the given size is placed, the determination target image area JIA image area determined as corresponding to the image of the face may be avoided. In this way, the process speed is increased.

In the above-described embodiments, image data stored on the memory card MC is set as the original image data. The original image data is not limited to image data stored on the memory card MC. For example, the original image data may be received via a network.

In the above-described embodiments, the right eye and the left eye are set, and the right-eye area EA(r), the left-eye area EA(l), and the mouth area MA are then detected. The type of part of the face to be set is modifiable. For example, either of the right and left eyes or both of the right and left eyes may be set as the type of part of the face. In addition to the right eye, the left eye, and the mouth, or instead of at least one of the right eye, the left eye, and the mouth, another type of part of the face (such as the nose or the eyebrow) may be set, and an area corresponding to such a part may be detected as the part area.

In the above-described embodiments, the face area FA and the part area are rectangular. Alternatively, the face area FA and the part area may have another shape other than a rectangular shape.

The above-described embodiments are related to the image processing process performed by the printer 100 as the image processing apparatus. Part or all of the image processing process may be performed by another type of image processing apparatus, such as a personal computer, a digital still camera, or a digital video camera. The printer 100 is not limited to an ink jet printer. The printer 100 may be another type of printer such as a laser printer or a sublimation printer.

In the above-described embodiments, part of the embodiment implemented using hardware may be implemented using software. Conversely, part of the embodiment implemented using software may be implemented using hardware.

If part or all of the functions of the invention are implemented using software (a computer program), the software may be supplied on a computer readable recording medium. A “computer readable recording medium” in the invention is not limited to a removable recording medium such as a flexible disk or a CD-ROM, but also includes an internal recording device such as a RAM, a ROM, and an external recording device fixed to a computer, such as a hard disk.

What is claimed is:

1. An image processing apparatus, comprising:
an application identification information acquisition unit that acquires application identification information that identifies an application of detection results of a face area corresponding to an image of a face in a target image;
a condition setting unit that sets a condition, relating to an angle of the face to be represented in the face area, based on the application identification information; and
a face area detection unit that detects the face area corresponding to the image of the face satisfying the set condition, based on image data representing the target image.

2. The image processing apparatus according to claim 1, wherein the condition relates to at least one of an angle of rotation of the face to be represented in the face area about an axis substantially perpendicular to a plane of the image and an angle of rotation of the face about an axis extending substantially in parallel with the plane of the image.

3. The image processing apparatus according to claim 1, wherein the face area detection unit comprises:
a determination target setter that sets a determination target image area as an image area on the target image;
a storage that stores a plurality of pieces of evaluation data, the plurality of pieces of evaluation data being predetermined in response to a value set as the condition and being used to calculate an evaluation score that represents a likelihood that the determination target image area is an image area corresponding to the image of the face satisfying the set condition;
an evaluation score calculator that calculates the evaluation score, based on the evaluation data corresponding to the set condition and image data corresponding to the determination target image area; and
an area setting unit that sets the face area based on the evaluation score and a position and a size of the determination target image area.

4. The image processing apparatus according to claim 3, wherein the area setting unit determines based on the evaluation score whether the determination target image area is the image area corresponding to the image of the face satisfying the set condition, and sets the face area based on the position and size of the determination target image area that has been determined as the image area corresponding to the image of the face satisfying the set condition.

5. The image processing apparatus according to claim 1, wherein the application comprises a predetermined image processing process that processes the image area set in accordance with the detected face area.

6. The image processing apparatus according to claim 5, wherein the predetermined image processing process comprises at least one of a skin complexion correction operation, a metamorphosis operation, a red-eye correction operation, a determination operation determining an expression of the image of the face, and a detection operation detecting the image of the face having a particular tilt and a particular size.

7. The image processing apparatus according to claim 1, further comprising an image generator that generates the image data by capturing an image of a subject,
wherein the application sets a timing of capturing the image of the subject.

8. An image processing method, comprising:
acquiring application identification information that identifies an application of detection results of a face area corresponding to an image of a face in a target image;
setting a condition, relating to an angle of the face to be represented in the face area, based on the application identification information; and
detecting the face area corresponding to the image of the face satisfying the set condition, based on image data representing the target image.

9. A computer program embodied in a computer-readable medium for causing a computer to process an image, comprising:
acquiring application identification information that identifies an application of detection results of a face area corresponding to an image of a face in a target image;
setting a condition, relating to an angle of the face to be represented in the face area, based on the application identification information; and
detecting the face area corresponding to the image of the face satisfying the set condition, based on image data representing the target image.
